(19) United States
(12) Patent Application Publication
(10) Pub. No.: US 2025/0048227 A1
(43) Pub. Date: Feb. 6, 2025

(54) NUMBER-OF-TARGET ESTIMATION SYSTEM, NUMBER-OF-TARGET ESTIMATION METHOD, AND STORAGE MEDIUM

(71) Applicant: KABUSHIKI KAISHA TOSHIBA, Tokyo (JP)

(72) Inventors: Toshihisa NABETANI, Kawasaki Kanagawa (JP); Daiki YODA, Yokohama Kanagawa (JP)

(73) Assignee: KABUSHIKI KAISHA TOSHIBA, Tokyo (JP)

(21) Appl. No.: 18/590,476

(22) Filed: Feb. 28, 2024

(30) Foreign Application Priority Data
Aug. 3, 2023 (JP) 2023-126888

(51) Int. Cl. H04W 40/02; G06V 40/10

(52) U.S. Cl. CPC H04W 40/02; G06V 40/10

(57) ABSTRACT

According to one embodiment, an estimation system tentatively estimating the number of targets existing in a first area, based on radio information or image information excluding wireless propagation path information, which is related to the first area, receiving a radio signal transmitted from a radio in the first area and acquiring wireless propagation path information from the received signal, and performing a final number-of-target estimation by machine learning, using a result of the tentative estimation and the acquired wireless propagation path information as input information. The estimation system selects models to be used for the estimation of the machine learning, based on a result of the tentative estimation, when performing the final number-of-target estimation.

### CROSS-REFERENCE TO RELATED APPLICATIONS

This application is based upon and claims the benefit of priority from Japanese Patent Application No. 2023-126888, filed Aug. 3, 2023, the entire contents of which are incorporated herein by reference.

### FIELD

Embodiments described herein relate generally to a number-of-target estimation system, a number-of-target estimation method, and a storage medium.

### BACKGROUND

As part of study of human flow estimation, a number-of-person estimation device for obtaining a signal transmitted from a terminal and estimating the number of persons using an identifier in a signal has been proposed (see, for example, Patent Literature 1: JP 2021-128599 A).

In addition, a CSI information processing method for accurately estimating the number of persons using wireless propagation path information (CSI: Channel Status Information) is known (see, for example, Non Patent Literature 1: H. ZOU, Y. ZHOU, J. YANG, W. GU, L.XIE AND C. SPANOS, “FREECOUNT: DEVICE-FREE CROWD COUNTING WITH COMMODITY WIFI” GLOBECOM 2017-2017 IEEE GLOBAL COMMUNICATIONS CONFERENCE, SINGAPORE, 2017, PP. 1-6, DOI:10.1109/GLOCOM.2017.8255034).

A method of the Patent Literature 1 is a number-of-person estimation method using only signal ID information such as MAC address. In contrast, a method of the Non Patent Literature 1 is a number-of-person estimation method using only CSI information.

Any of the methods has a problem that further improvement of the accuracy cannot be desired since each estimation is executed independently using the signal ID information or the CSI information.

### BRIEF DESCRIPTION OF THE DRAWINGS

FIG. 1 is a diagram showing an example of a configuration of a number-of-target estimation system of an embodiment.

FIG. 2 is a diagram illustrating an overview of number-of-target determination using CSI in the number-of-target estimation system of the embodiment.

FIG. 3 is a diagram illustrating an overall model and a plurality of partial models in the number-of-target estimation system of the embodiment.

FIG. 4 is a diagram further illustrating the plurality of partial models in the number-of-target estimation system of the embodiment.

FIG. 5 is a diagram illustrating a method of selecting an appropriate model in the number-of-target estimation system of the embodiment.

FIG. 6 is a flowchart showing a procedure of a number-of-person estimation process in the number-of-target estimation system of the embodiment.

### DETAILED DESCRIPTION

In general, according to one embodiment, a number-of-target estimation system includes a first number-of-target estimation unit, a wireless propagation path acquisition unit, and a second number-of-target estimation unit. The first number-of-target estimation unit estimates the number of targets existing in a first area, based on radio information or image information excluding wireless propagation path information, which is related to the first area. The wireless propagation path acquisition unit acquires wireless propagation path information, based on a radio signal transmitted from a radio in the first area. The second number-of-target estimation unit performs a final number-of-target estimation by machine learning, using a result of the estimation of the first number-of-target estimation unit and the wireless propagation path information acquired by the wireless propagation path acquisition unit as input information. The second number-of-target estimation unit selects models to be used for the estimation of the machine learning, based on the result of the estimation of the first number-of-target estimation unit.

Embodiments will be described hereinafter with reference to the accompanying drawings.

FIG. 1 is a diagram showing an example of a configuration of a number-of-target estimation system 1 according to an embodiment.

In recent years, human flow estimation has been studied as part of building solution, and the human flow estimation using camera images, and the like has been studied, but human flow estimation in a non-video system has also been studied from the viewpoint of cost of installed equipment, blind spots, security, and the like.

Wireless Local Area Network (LAN) is expected to be one of the sensing information for non-video-based estimation since it is highly likely that the network is already installed as building equipment and enables sensing without installing new equipment. Basically, the number of terminals connected to each access point (AP) that forms a service area of the wireless network is considered as the number of users present in the area covered by each AP to count the number of persons. However, it is difficult to accurately estimate the number of users based solely on the number of connected devices since several users do not own terminals or own a plurality of terminals.

In contrast, estimation of the number of people using CSI has been noticed, and a number of studies have been conducted, but there is room for improvement in terms of the estimation accuracy in each case.

A number-of-target estimation system 1 of the embodiment has realized a mechanism to improve the accuracy in estimation of the number of persons, using wireless propagation path information, by using the information on the number of terminals connected to the AP, and this point will be described in detail below. Incidentally, this mechanism is not limited to non-video-based human flow estimation, but can also be realized by, for example, utilizing cameras which have already been installed and combining the cameras with the video-based human flow estimation.

As shown in FIG. 1, the number-of-target estimation system 1 includes a first target estimation unit 11, a wireless propagation path acquisition unit 12, and a second target estimation unit 13. The first target estimation unit 11, the wireless propagation path acquisition unit 12, and the second target estimation unit 13 may be configured by a central processing unit (CPU) executing a program or may be configured as hardware such as electric circuits. In addition, the first target estimation unit 11, the wireless propagation path acquisition unit 12, and the second target estimation unit 13 may be configured in the same hardware or each of the units may be configured on different hardware to receive and pass information through an interface such as an Ethernet (registered trademark) cable.

The first target estimation unit 11 estimates the number of targets present in the target area using, for example, wireless information on the terminals connected to the AP which covers the target area, more specifically, identifiers such as MAC addresses in signals transmitted from the terminals, or image information from images obtained by capturing the target area.

Various known methods can be applied to the method of estimating the number of targets by the first target estimation unit 11. When the information on the target area is wireless information, the first target estimation unit 11 detects, for example, the number of terminals connected to the AP. In addition, when the information on the target area is the image information, the first target estimation unit 11 detects, for example, the number of target-like subject images by analyzing the images. The number-of-target estimation system 1 of the embodiment treats the result of the estimation using the first target estimation unit 11, i.e., the estimated number of targets, as a tentatively estimated number of targets (primary estimation result).

The wireless propagation path acquisition unit 12 acquires CSI from the signals transmitted from the terminals connected to the AP. It is assumed that the wireless propagation path acquisition unit 12 receives the signals from the terminals connected to the AP by itself and acquires CSI from the received signals, but the acquisition is not limited to this method and, for example, other devices or systems may receive the signals transmitted from the terminals connected to the AP and acquire CSI from the received signals and the wireless propagation path acquisition unit 12 may receive the CSI from the other devices or systems.

The second target estimation unit 13 performs a final number-of-target estimation by machine learning using the result of estimation of the first target estimation unit 11 and the CSI acquired by the wireless propagation path acquisition unit 12 as input information (to obtain a secondary estimation result). At that time, the second target estimation unit 13 selects a model to be used in the estimation using machine learning, based on the result of estimation of the first target estimation unit 11.

Thus, in the number-of-target estimation system 1 of the embodiment, a plurality of partial models in which the number of targets is limited are prepared, a partial model to be used is selected among them and used based on the number of targets tentatively estimated by the first target estimation unit 11, and the final number-of-target estimation is performed by the second target estimation unit 13. Thus, since the number-of-target estimation system 1 of the embodiment can be performed in the model whose candidates are limited in advance, the improvement in estimation accuracy can be expected, as compared to a case of using a single large overall model including the number of targets tentatively estimated by the first target estimation unit 11 and performing the final number-of-target estimation by the second target estimation unit 13. The overall model and a plurality of partial models will be described below.

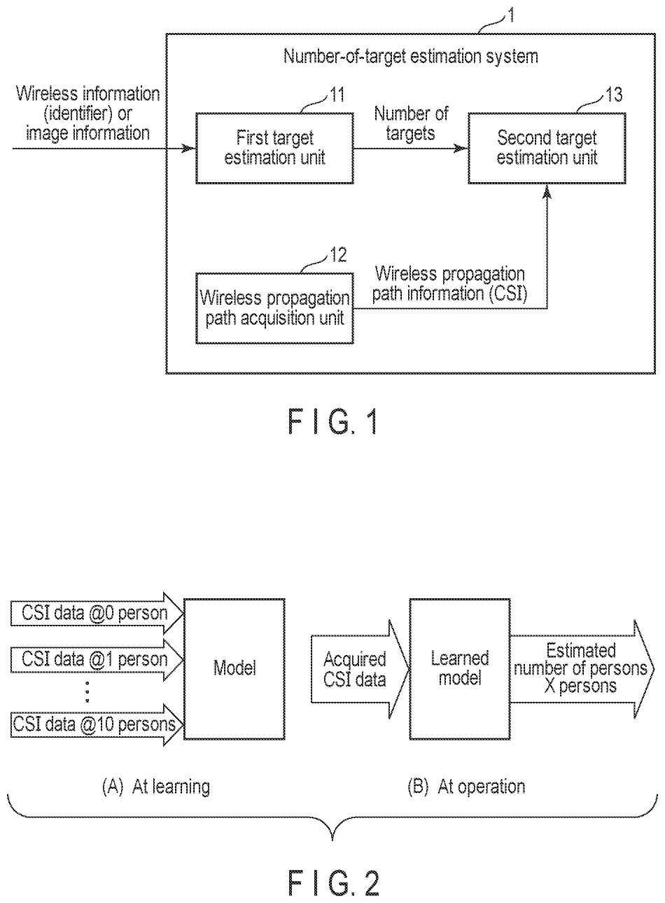

An overview of the number-of-target determination using the CSI will be described with reference to FIG. 2.

In supervised learning, the model (DNN, CNN, or the like) is given data to be determined and their labels, and learning is performed so as to select the desired model when given unknown data. In the present embodiment, the input data is CSI data, and the data is acquired in a state in which target objects in the target range (area) are X persons (or pieces).

FIG. 2 shows, as an example, an operation in a case where the target objects are humans and eleven types of data are prepared in a range from a state where no persons exist in the target range (0 persons) to a state where ten persons exist in the target range.

As shown in FIG. 2(A), eleven types of data are input and labels corresponding to the input data are processed to be obtained via the model, at the learning. In contrast, as shown in FIG. 2(B), the actually acquired CSI data is input and the estimated number of persons X is output, at the operation. Since learning is performed using the data from 0 to 10 persons at the learning, the estimated output X generally takes values from 0 to 10.

Next, the overall model and a plurality of partial models will be described.

As an example, the estimation of the number of persons in a case where 0 to 10 persons exist in the target range will be subsequently considered.

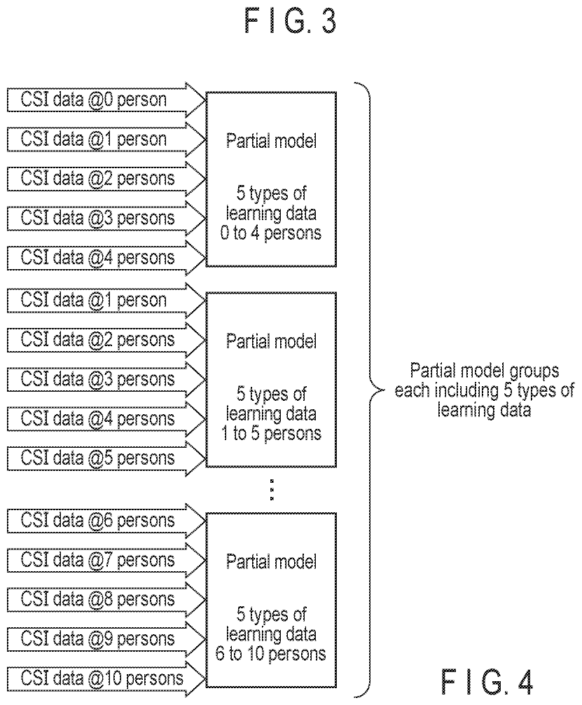

First, FIG. 3 shows an overall model with eleven types of input CSI data as FIG. 3(A). Similarly to FIG. 2, when unknown CSI data is input, this model determines which of 0 to 10 persons is the estimated number of persons, by using all types of acquired CSI data for the learning.

In addition, second, FIG. 3 shows a partial model whose input data is input and to which only data of 2 to 6 persons is input, as FIG. 3(B). In this partial model, since only data from 2 to 6 persons are learned, this model is generally used as a model for determining to which of 2 to 6 persons the input CSI data corresponds.

Two models in FIG. 3(A) and FIG. 3(B) will be compared. In the estimation using the partial model in FIG. 3(B), higher estimation accuracy can be obtained while candidates are limited, on the assumption that the number of targets to be estimated is limited to 2 to 6 persons.

Next, the plurality of partial models will be further described with reference to FIG. 4. Similarly to FIG. 3(B), partial models with five types of input CSI data are listed in FIG. 4.

In the case of estimating the number of subjects up to 10 persons, similarly to the current case, a maximum of 7 types of partial models in which 5 consecutive types of CSI data are input and learned can be created. The CSI data in a case where a target person is one person may be included in the first upper partial model and the second partial model, and thus the same data set may be included in different models as the input. In addition, not only the partial models with five consecutive types of learning data, but also partial models with three consecutive types or six consecutive types of learning data may be created.

The number-of-target estimation system 1 of the embodiment can perform more accurate estimation of the number of persons by, for example, selecting an appropriate model from among a plurality of models that are sets of such partial models.

Next, a method of selecting an appropriate model will be described.

In the number-of-target estimation system 1 of the embodiment, it is desirable to select a model of supervised learning in which the number of targets estimated by the first target estimation unit 11 is included as an input label. For example, if the number of targets estimated by the first target estimation unit 11 is four, it is desirable to perform estimation using the partial model including the CSI data of 4 persons in FIG. 3(B) (the third partial model of seven types of partial models in FIG. 4). If the number of targets estimated by the first target estimation unit is 8 but the partial model in FIG. 3(B) is used, the estimation result of the second target estimation unit 13 is any of 2 to 6 persons regardless of the input data, and it is highly unlikely that a correct result cannot be obtained.

In other words, the number-of-target estimation system 1 of the embodiment can improve the accuracy of a secondary number-of-target estimation result (i.e., the estimation result of the second target estimation unit 13) by properly utilizing a primary number-of-target estimation result (i.e., the estimation result of the first target estimation unit 11).

Incidentally, if the number of targets estimated by the first target estimation unit is 8 persons, the lowest of the seven types of partial models in FIG. 4 is desirably used.

In addition, the number-of-target estimation system 1 of the embodiment may perform model selection by further using the information on the certainty (accuracy/error/confidence/distribution, and the like) of the number of targets as input data, other than the number of targets estimated by the first target estimation unit 11.

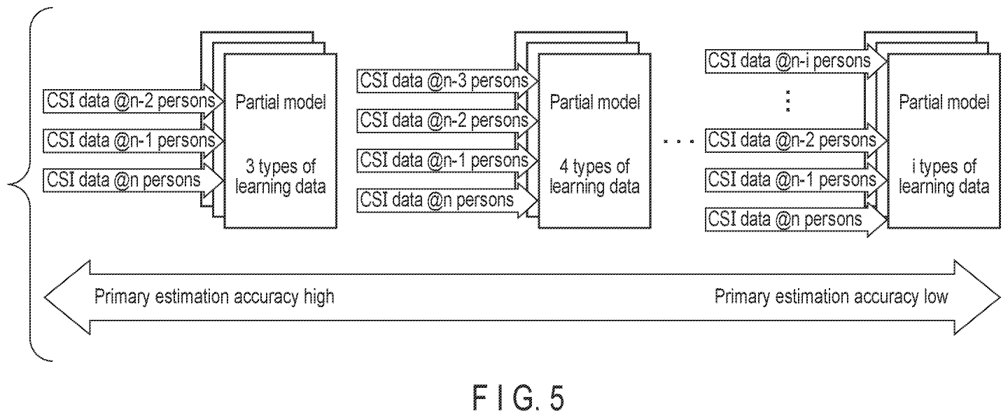

It is assumed that if the accuracy of the estimation result of the first target estimation unit 11 is very high, for example, if the estimated number result is N, an assumable error is known to be ±1. In such a case, as shown in FIG. 5, the most accurate secondary estimation result can be obtained in the second target estimation unit 13 if a model with three types of learning data, which has been learned using ±1 CSI data centered on N is used as the partial model.

In contrast, if the accuracy of the estimation result of the first target estimation unit 11 is low, if the primary estimation result is N, and if the assumable error is ±3, a model with seven types of learning data, which has been learned using ±3 CSI data centered on N, needs to be used.

If a model with three types of learning data, which has been learned using ±1 learning data centered on N, is used and if a true number is N+2 or more or N−2 or less, the correct result can never be obtained. Therefore, as described above, the number-of-target estimation system 1 of the embodiment can perform more accurate estimation by determining the scale of the partial model to be selected in accordance with the certainty.

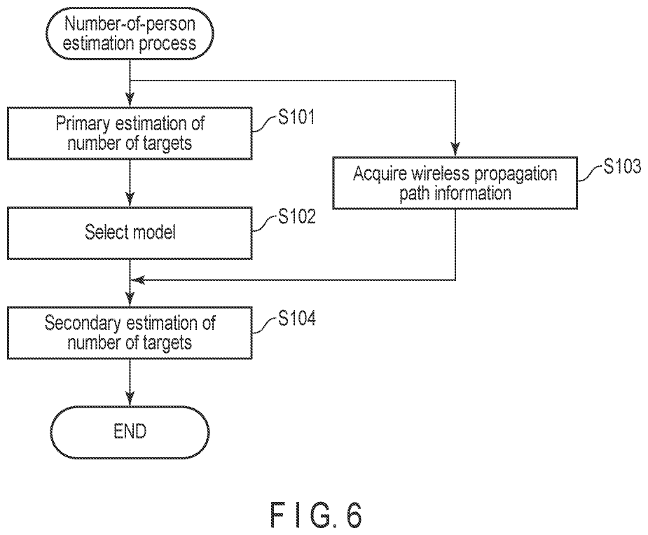

FIG. 6 is a flowchart showing a procedure of the number-of-person estimation process in the number-of-target estimation system 1 of the embodiment.

After the estimation of the number of persons is started, primary number-of-target estimation is conducted in the first target estimation unit 11 (S101). The primary number-of-target estimation result can be obtained from this primary estimation. The number-of-target estimation system 1 selects a model to be used in the second target estimation unit 13, using the primary number-of-target estimation result (S102).

In addition, wireless propagation path information is acquired in the wireless propagation path acquisition unit 12, concurrently with the processes in step S101 and step S102 (S103).

Then, the secondary number-of-target estimation result is obtained from the second target estimation unit 13 by inputting the wireless propagation path information obtained in S103 to the model selected in S102 (S104), and the number-of-person estimation process is ended.

As described above, in the number-of-target estimation system 1 of the embodiment, the estimation accuracy of the second target estimation unit 13 can be improved by selecting the model used in the second target estimation unit 13 using the primary estimation result.

In the number-of-target estimation system 1 of the embodiment, by dividing the wireless propagation path information into a plurality of data sets and by holding a plurality of models learned on each data set in advance, the model necessary to perform the secondary estimation with the highest accuracy can be selected based on the estimation result of the first target estimation unit 11.

In addition, in the number-of-target estimation system 1 of the embodiment, by selecting a model for supervised learning, which includes the number of targets estimated by the first target estimation unit 11 as an input label, at least the same result as the primary estimation result is included in the secondary estimation result obtained from that model. As a result, the secondary estimation can be performed more accurately based on the primary estimation result.

In addition, in the number-of-target estimation system 1 of the embodiment, by selecting a model by adding the certainty of the primary estimation result as input data, an appropriate model corresponding to the certainty can be selected and more accurate secondary estimation result can be further obtained.

In addition, in the number-of-target estimation system 1 of the embodiment, the same labeled wireless propagation path information data sets can be input even between different models. In other words, by allowing overlap of data sets between different models, the number-of-target estimation system 1 of the embodiment can increase model choices, enable more fine appropriate models to be selected in accordance with the situation, and further improve the estimation accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A number-of-target estimation system comprising:
a first number-of-target estimation unit configured to estimate the number of targets existing in a first area, based on radio information or image information excluding wireless propagation path information, which is related to the first area;
a wireless propagation path acquisition unit configured to acquire wireless propagation path information, based on a radio signal transmitted from a radio in the first area; and
a second number-of-target estimation unit configured to perform a final number-of-target estimation by machine learning, using a result of the estimation of the first number-of-target estimation unit and the wireless propagation path information acquired by the wireless propagation path acquisition unit as input information, wherein
the second number-of-target estimation unit is configured to select models to be used for the estimation of the machine learning, based on the result of the estimation of the first number-of-target estimation unit.

2. The number-of-target estimation system of claim 1, wherein
the first number-of-target estimation unit is configured to estimate the number of targets, based on the number of terminal connections to an access point, which is managed at the access point forming a service area of a wireless network in the first area.

3. The number-of-target estimation system of claim 1, wherein
the first number-of-target estimation unit is configured to analyze an image obtained by capturing the first area and estimates the number of targets.

4. The number-of-target estimation system of claim 1, wherein
models to be used for the estimation of the machine learning, which are targets of selection of the second number-of-target estimation unit, are a plurality of independent models trained by dividing wireless propagation path information labeled with each number of targets within a range up to an assumable maximum estimated number of targets and inputting different combinations of data set groups among the plurality of data sets.

5. The number-of-target estimation system of claim 4, wherein
the second number-of-target estimation unit is configured to select a model of supervised learning in which the number of targets estimated by the first number-of-target estimation unit is included as an input label.

6. The number-of-target estimation system of claim 4, wherein:
models to be used for the estimation of the machine learning are a plurality of independent models trained by inputting a data set group in which numbers of labels included are different from one another; and
the second number-of-target estimation unit is configured to
further use certainty on the result of the estimation of the first number-of-target estimation unit as input information from the first number-of-target estimation unit, and
select a model with a smaller number of labels included in the data set as the certainty on the result of the estimation of the first number-of-target estimation unit is higher.

7. The number-of-target estimation system of claim 4, wherein
the plurality of independent models are capable of inputting a data set of wireless propagation path information labeled in the same manner between different models.

8. A number-of-target estimation method comprising:
tentatively estimating the number of targets existing in a first area, based on radio information or image information excluding wireless propagation path information, which is related to the first area;
receiving a radio signal transmitted from a radio in the first area and acquiring wireless propagation path information from the received signal; and
performing a final number-of-target estimation by machine learning, using a result of the tentative estimation and the acquired wireless propagation path information as input information, wherein
the performing the final number-of-target estimation includes selecting models to be used for the estimation of the machine learning, based on a result of the tentative estimation.

9. The number-of-target estimation method of claim 8, wherein
the tentatively estimating the number of targets includes estimating the number of targets, based on the number of terminal connections to an access point, which is managed at the access point forming a service area of a wireless network in the first area.

10. The number-of-target estimation method of claim 8, wherein
the tentatively estimating the number of targets includes analyzing an image obtained by capturing the first area and estimates the number of targets.

11. The number-of-target estimation method of claim 8, wherein
models to be used for the estimation of the machine learning, which are targets of selection of the performing the final number-of-target, are a plurality of independent models trained by dividing wireless propagation path information labeled with each number of targets within a range up to an assumable maximum estimated number of targets and inputting different combinations of data set groups among the plurality of data sets.

12. The number-of-target estimation method of claim 11, wherein
the performing the final number-of-target estimation includes selecting a model of supervised learning in which the number of targets estimated by the first number-of-target estimation unit is included as an input label.

13. The number-of-target estimation method of claim 11, wherein
models to be used for the estimation of the machine learning are a plurality of independent models trained by inputting a data set group in which numbers of labels included are different from one another; and
the performing the final number-of-target estimation
further uses certainty on the result of the estimation of the first number-of-target estimation unit as input information from the first number-of-target estimation unit, and
includes selecting a model with a smaller number of labels included in the data set as the certainty on the result of the estimation of the first number-of-target estimation unit is higher.

14. The number-of-target estimation method of claim 11, wherein
the plurality of independent models are capable of inputting a data set of wireless propagation path information labeled in the same manner between different models.

15. A non-transitory computer-readable storage medium having stored thereon a computer program which is executable by a computer, the computer program controlling the computer to execute functions of:
tentatively estimating the number of targets existing in a first area, based on radio information or image information excluding wireless propagation path information, which is related to the first area;
receiving a radio signal transmitted from a radio in the first area and acquiring wireless propagation path information from the received signal; and
performing a final number-of-target estimation by machine learning, using a result of the tentative estimation and the acquired wireless propagation path information as input information, wherein
the performing the final number-of-target estimation includes selecting models to be used for the estimation of the machine learning, based on a result of the tentative estimation.

16. The storage medium of claim 15, wherein
the tentatively estimating the number of targets includes estimating the number of targets, based on the number of terminal connections to an access point, which is managed at the access point forming a service area of a wireless network in the first area.

17. The storage medium of claim 15, wherein
the tentatively estimating the number of targets includes analyzing an image obtained by capturing the first area and estimates the number of targets.

18. The storage medium of claim 15, wherein
models to be used for the estimation of the machine learning, which are targets of selection of the performing the final number-of-target, are a plurality of independent models trained by dividing wireless propagation path information labeled with each number of targets within a range up to an assumable maximum estimated number of targets and inputting different combinations of data set groups among the plurality of data sets.

19. The storage medium of claim 18, wherein
the performing the final number-of-target estimation includes selecting a model of supervised learning in which the number of targets estimated by the first number-of-target estimation unit is included as an input label.

20. The storage medium of claim 18, wherein
models to be used for the estimation of the machine learning are a plurality of independent models trained by inputting a data set group in which numbers of labels included are different from one another; and
the performing the final number-of-target estimation
further uses certainty on the result of the estimation of the first number-of-target estimation unit as input information from the first number-of-target estimation unit, and
includes selecting a model with a smaller number of labels included in the data set as the certainty on the result of the estimation of the first number-of-target estimation unit is higher.
